(19) United States
(12) Patent Application Publication
(10) Pub. No.: US 2026/0317549 A1
(43) Pub. Date: Oct. 15, 2026

(54) YELLOW METAL INTERFERENCE PIGMENTS HAVING A GREEN TINT, METHOD FOR PREPARING SAME, AND USE THEREOF

(71) Applicant: SCHLENK METALLIC PIGMENTS GMBH, Roth (DE)

(72) Inventors: Yvonne BINDER, Allersberg (DE); Fabian PIECH, Wendelstein (DE); Adalbert HUBER, Bensheim (DE)

(21) Appl. No.: 19/101,264

(22) PCT Filed: Jun. 29, 2023
(86) PCT No.: PCT/EP2023/067835

§ 371 Date: Feb. 5, 2025

(30) Foreign Application Priority Data
Sep. 13, 2022 (EP) 22195362.3

(51) Int. Cl. C09C 1/00; C09C 3/06

(52) U.S. Cl. CPC C09C 1/0051; C09C 3/063; C01P 2004/20; C01P 2004/61; C01P 2004/80; C01P 2006/66; C09C 2220/10

(57) ABSTRACT

The present invention relates to metal interference pigments comprising aluminum platelets having an average thickness in the range of from 5 nm to 600 nm, which are optionally passivated and which are coated with a layer A and a layer B in this order, wherein layer A is composed of silicon dioxide and layer B is composed of iron(III) oxide doped with a dopant element selected from the group consisting of tungsten, indium, gallium and titanium, wherein the molar fraction of the dopant element in layer B, based on the total molar amount of iron and the dopant element, is from 0.5 mol % to 10 mol %, and wherein 60 to 85 parts by mass of iron(III) oxide, based on 10 parts by mass of aluminum, are present in the metal interference pigments. Moreover, the present invention relates to a method for producing the metal interference pigments and to the use of the metal interference pigments according to the present invention.

The present invention relates to yellow metal interference pigments with a green tint, a method for producing the same and the use thereof.

In recent years, metal interference pigments have become established for coloring paints, printing inks, inks, plastics, glasses, ceramics and decorative cosmetic preparations. Metal interference pigments are characterized by the fact that a metal substrate, for example a metal substrate made of aluminium, which may be stabilized with a layer of silicon dioxide on top, is enclosed by a highly refractive metal oxide layer, such as a layer of iron(III) oxide. As the metal substrate is opaque, metal interference pigments have a high hiding power in contrast to pearlescent pigments, which comprise a translucent substrate.

When light is incident on the metal interference pigments, part of the incident light penetrates the high refractive index metal oxide layer, while the other part of the incident light is reflected at the surface of the high refractive index metal oxide layer. The part of the incident light that penetrates the high refractive index metal oxide layer is finally reflected at the surface of the metal substrate. The light rays reflected at the surface of the metal substrate and the light rays reflected at the surface of the highly refractive metal oxide layer exhibit a path difference, which results in an interference phenomenon that is ultimately responsible for the coloration of the metal interference pigments. A suitable selection of the highly refractive metal oxide layer can be used to set the desired color tone, whereby the refractive index and the layer thickness also have an influence on the color tone.

For a variety of applications, it is desirable that the metal inference pigments used have a yellow hue with a green tint, equivalent to a hue angle h_{ab}15° of at least 85. At the same time, it is desirable that said metal inference pigments have a high color saturation, equivalent to a hue (chroma) C*_{ab}15° of at least 55.

The metal interference pigments currently available on the market do not meet the above requirements.

For example, the metal interference pigments Zenexo® GoldenShine from Schlenk Metallic Pigments GmbH, Meoxal® Taklamakan Gold from Merck KGaA and Paliocrom® Gold from Sun Chemical Colors & Effects GmbH only show a yellow hue without a green tint. In this context, reference is also made to the metal interference pigments disclosed in WO 2019/063372 A1, whose hue angle is only in the range of 68 to 78, which is not yet a greenish yellow.

The present invention is thus based on the object of providing yellow metal interference pigments with a green tint, whereby the metal interference pigments to be provided should also have a high color saturation.

The above object is achieved by providing the metal interference pigments according to the present invention, comprising aluminum platelets having an average thickness in the range of from 5 nm to 600 nm, which are optionally passivated and which are coated with a layer A and a layer B in this order,
wherein layer A is composed of silicon dioxide and layer B is composed of iron(III) oxide doped with a dopant element selected from the group consisting of tungsten, indium, gallium and titanium,
wherein the molar fraction of the dopant element in layer B, based on the total molar amount of iron and the dopant element, is from 0.5 mol % to 10 mol %, and
wherein 60 to 85 parts by mass of iron(III) oxide, based on 10 parts by mass of aluminum, are present in the metal interference pigments.

The metal interference pigments according to the invention, which can be obtained by the manufacturing process according to the invention described below, are characterized by a yellow shade with a green tint. This is achieved by doping the highly refractive metal oxide layer with small amounts of a specific dopant element in addition to iron(III) oxide. Doping allows the hue angle of the metal interference pigments to be shifted towards higher values without having to accept losses in terms of hue.

The metal interference pigments according to the invention are described in more detail below.

As already mentioned above, the metal interference pigments according to the invention comprise aluminum platelets. The aluminum platelets serving as metal substrate may be passivated, i.e. they may be coated with a native oxide layer. The thickness of the native oxide layer is typically in the range of 3 nm to 5 nm and is included in the thickness of the aluminum platelets in the context of the present invention, as indicated below.

According to the present invention, the aluminum platelets have an average thickness in the range of from 5 nm to 600 nm, preferably in the range of from 5 nm to 400 nm, more preferably in the range of from 5 nm to 200 nm, even more preferably in the range of from 5 nm to 100 nm, for example in the range of from 10 nm to 50 nm or in the range of from 15 nm to 30 nm.

By using thin aluminum platelets, a particularly high hiding power can be achieved, since a larger area of the surface to be covered with the metal interference pigments can be covered with the same mass of aluminum. The average thickness of the aluminum platelets is their mean thickness, which is to be understood as the arithmetic mean of all measured thicknesses. The average thickness of the aluminum platelets is determined by measurement on the basis of scanning transmission electron microscope (STEM) images. The average thickness of the aluminum platelets is the average value of at least 200 measurements of different aluminum platelets.

As far as the size of the aluminum platelets, i.e. their diameter, is concerned, the present invention is not further limited. The diameter of the aluminum platelets in the present case is the so-called d₅₀. This indicates the value at which 50% of the aluminum platelets from a random sample are smaller than the specified value. Without being limited to this, the diameter d₅₀ of the aluminum platelets is typically 5 μm to 100 μm, for example 5 μm to 50 μm or 10 μm to 30 μm. The diameter d₅₀ of the aluminum platelets is determined by measurement based on laser light diffraction according to DIN ISO 13320:2020-01 using a commercially available particle size analyzer, such as that commercially available from Sympatec GmbH (Helios BF, with Quixel wet dispersion, lens 3).

The ratio between the diameter d₅₀ of the aluminum platelets and the average thickness of the aluminum platelets, which is also referred to as the aspect ratio, is also not subject to any particular restriction in the present case. It can lie in a range of from 50 to 5000, 100 to 2000 or 200 to 1000, but is not limited to this.

Ideally, the aluminum platelets have a thickness SPAN (t_{SPAN}) in the range of from 0.1 to 0.4, preferably in the range of from 0.1 to 0.3, for example in the range of from 0.1 to 0.2, but without being limited to this. The thickness SPAN results from the width of the thickness distribution and is calculated according to the following formula:

$${t}_{SPAN} = \frac{{t}_{90} - {t}_{10}}{{t}_{50}}$$

As with the diameter d₅₀, the indices in the above formula represent the respective value in the cumulative distribution curve. t₁₀ therefore means that 10% of the aluminum platelets are thinner than the thickness t₁₀. Correspondingly, 90% of the aluminum platelets have a thickness equal to or greater than the thickness t₁₀. Analogous considerations apply for the thickness t₅₀ and for the thickness t₉₀.

Finally, the thickness variation (Δh) is obtained as a percentage from the thickness SPAN:

$$Δ h = {t}_{SPAN} \times 100 \%$$

A thickness SPAN in the range of 0.1 to 0.4 therefore means a thickness variation in the range of 10% to 40%.

The aluminum platelets can be those from wet grinding. According to their appearance, aluminum platelets obtained by wet grinding are also referred to as “cornflakes” or “silver dollars”. While aluminum platelets of the “cornflake” type, which is also known as the lamellar type, have irregular and jagged side edges, aluminum platelets of the “silver dollar” type, which is also known as the lenticular type, usually have rounded edges.

Instead of wet grinding, the aluminum platelets can also be obtained by physical vapor deposition (PVD). The aluminum platelets obtained in this way are also referred to as vacuum-metallized pigments (VMPs). According to their appearance, they are polygons with straight side edges. Due to their manufacturing process, vacuum-metallized pigments have an extremely low thickness variation and are also significantly smoother than aluminum platelets from wet grinding. metal interference pigments based on vacuum-metallized pigments not only have excellent color saturation, but are also excellent in terms of their hiding power. Preferably, the aluminum platelets of the metal interference pigments according to the invention are therefore vacuum-metallized pigments. Vacuum-metallized pigments are commercially available from various suppliers. In this context, the vacuum-metallized pigments Decomet® from Schlenk Metallic Pigments GmbH, METALURE® from Eckart GmbH and Metasheen® from Sun Chemical Colors & Effects GmbH should be mentioned, for example.

According to the present invention, the aluminum platelets are coated with a layer A and a layer B in this order. A layer A is thus initially applied to the aluminum platelets. A layer B is in turn applied to this layer. The layer A and the layer B thus envelop the aluminum platelets, with the layer A being arranged between the aluminum platelets and the layer B. Typically, the aluminum platelets are coated with layer A and layer B in such a way that the coating is complete in each case.

Layer A, which is made of silicon dioxide and has a low refractive index (refractive index n≤1.8), serves to stabilize the aluminum platelets. Layer A thus prevents the aluminum platelets from being directly exposed to the conditions that prevail during the subsequent formation of layer B.

Without being limited to this, layer A can have an average thickness in the range of from 5 nm to 200 nm, for example in the range of from 10 nm to 100 nm. For the determination of the average thickness of layer A, the explanations apply as they were made above in connection with the determination of the average thickness of the aluminum platelets, with the difference that only 100 samples are measured and evaluated by means of scanning electron microscopy (SEM) images.

Layer B, which in turn is highly refractive (refractive index n>1.8), is primarily responsible for the interference and thus also for the coloration of the metal interference pigments. In the present case, layer B is composed of iron(III) oxide, which is doped with a dopant element selected from the group consisting of tungsten, indium, gallium and titanium. The presence of the dopant element in layer B allows the refractive index of layer B to be influenced in such a way that the hue angle of the metal interference pigments is shifted towards larger values, as a result of which the metal interference pigments ultimately have a yellow color with a green tint. Preferably, the dopant element is tungsten, as this is readily available in the form of corresponding compounds.

As for the amount of the dopant element, the molar fraction of the dopant element in the layer B, based on the total molar amount of the iron and the dopant element, is 0.5 mol % to 10 mol %, preferably 1.0 to 8 mol %, and even more preferably 1.5 to 7 mol %. If the amount of dopant element is too small, a yellow color with a green tint is not yet achieved. If the amount of dopant element is too high, the color saturation is reduced, which is noticeable in a decrease in the hue of the metal interference pigments. The molar fraction of the dopant element in layer B, in relation to the total molar amount of iron and the dopant element, is determined using energy dispersive X-ray spectroscopy (EDX).

As already mentioned at the beginning, the thickness of layer B also influences the color tone in addition to the refractive index. Typically, layer B has an average thickness in the range of from 15 nm to 300 nm, whereby the average thickness of layer B can be in the range of from 25 nm to 200 nm or in the range of from 50 nm to 150 nm, for example. For the determination of the average thickness of layer B, the explanations apply as they were made above in connection with the determination of the average thickness of the aluminum platelets, with the difference that only 100 samples are measured and evaluated by means of scanning electron microscopy (SEM) images.

Both in the case of layer A and in the case of layer B, the thickness of the respective layer can be adjusted via the amount of the respective precursor compound added. With the same amount of aluminum platelets provided, the thickness of the respective layer increases the more of the respective precursor compound is added. The amount of precursor compound added is therefore adjusted in such a way that layer A and layer B have suitable thicknesses, for example in the above ranges. The precursor compounds of layer A and layer B will be discussed in more detail below in the description of the manufacturing method according to the invention.

According to the present invention, 60 to 85 parts by mass of iron(III) oxide are present in the metal interference pigments, based on 10 parts by mass of aluminum, for example 60 to 80 parts by mass or 60 to 75 parts by mass. The person skilled in the art is aware that if the aluminum platelets become thinner, the mass of iron(III) oxide must increase to achieve a certain layer thickness, provided that the mass of aluminum remains constant. The reason for this is that as the aluminum platelets become thinner, their surface area to be coated increases. The above considerations naturally apply not only to layer B, but also to layer A in the same way.

Layer B can be provided with a surface coating as layer C. Without limitation, the surface coating can be formed from organic polymers, silanes or siloxanes, for example. The surface coating can also be composed of silicon dioxide, as described below in connection with the manufacturing process according to the invention. In principle, combinations of silicon dioxide and silanes or the like are also possible.

The mechanical and chemical resistance of the metal interference pigments can be further increased by applying such a surface coating to layer B, which is also referred to as surface functionalization. However, such a surface coating is not absolutely necessary. Accordingly, the metal interference pigments can also consist of aluminum platelets with an average thickness in the range of 5 nm to 600 nm, which may be passivated and which are coated with a layer A and a layer B in this order. Apart from layer A and layer B, there are therefore no other layers on the optionally passivated aluminum platelets in this embodiment.

Due to their specific structure, as described above, the metal interference pigments according to the invention have a yellow hue with a green tint and high color saturation at the same time. In other words, the metal interference pigments according to the invention have a hue angle h_{ab}15° of at least 85 with a hue C*_{ab}15° of at least 55.

To determine the coloristic properties, namely the hue angles h_{ab}15° and the hue C*_{ab}15°, a coating formulation consisting of 0.7 g of the metal interference pigments and 9.3 g of a coating containing butanol-moist nitrocellulose and a polycyclohexanone resin as well as another resin based on a butyl acrylate-isobutyl vinyl ether (solids content of 8.5 mass %) is first prepared. The pigmentation is therefore 7% by mass. After mixing the coating formulation using a speed mixer from Hauschild & Co KG, which disperses the metal interference pigments in the coating formulation, it is then applied to a black and white test cardboard (DIN A5, with optical brightener) from TQC Sheen GmbH using a film applicator from Zehntner GmbH and a 38 μm squeegee from TQC Sheen GmbH. After the squeegee application with subsequent drying, first at room temperature, i.e. at 25° C., followed by drying at 60° C., the spectral reflection of a light beam incident on the measuring surface at an angle of 45° and emitted by a D65 light source is measured at six different detection angles (15°, 15°, 25°, 45°, 75° and 110°) for a 100 observer in accordance with DIN EN ISO 18314-3:2018-12 using a commercially available multi-angle spectrophotometer and converted into the corresponding values of the CIELAB color space. The measurement is carried out here on a “Color Scout A+” vacuum measuring table from ColorPartner GmbH with a “BYK-mac i” multi-angle spectrophotometer from BYK-Gardner GmbH. This is also used to determine the color distance ΔE110°, as described below.

In addition to their coloristic properties, the metal interference pigments according to the invention can also be characterized by their color distance ΔE110°. The color distance ΔE110° is a measure of the hiding power of the metal interference pigments, whereby a smaller color distance ΔE110° means a higher hiding power. When determining the color distance ΔE110°, a squeegee application is also required first, as described above, whereby the pigmentation here is also 7 mass %. The color distance is then measured in the geometry 45°/110° according to DIN 6175:2019-07 with a commercially available multi-angle spectrophotometer.

Due to the fact that the aluminum platelets serving as the metal substrate are opaque, the metal interference pigments according to the invention typically have a color distance ΔE110° of less than 1.5. This applies all the more if thin aluminum platelets are used, such as those with an average thickness in the range of from 5 nm to 30 nm, and/or if vacuum-metallized pigments are used for this purpose.

Furthermore, the present invention provides a method for producing the metal interference pigments according to the invention as described above, wherein the production method according to the invention comprises the following steps (a) to (c):
(a) providing aluminum platelets having an average thickness in the range of from 5 nm to 600 nm, which are optionally passivated;
(b) coating the aluminum platelets provided in step (a) with a layer A of silicon dioxide by hydrolytic decomposition of an organic silicon compound or by precipitation of water glass; and
(c) coating the layer A obtained in step (b) with a layer B of iron(III) oxide doped with a dopant element selected from the group consisting of tungsten, indium, gallium and titanium by precipitation of an iron salt in the presence of a dopant salt selected from the group consisting of a tungsten salt, an indium salt, a gallium salt and a titanium salt.

The metal interference pigments obtainable by the manufacturing process according to the invention have a yellow color with a green tint and high color saturation.

The manufacturing process according to the invention is described in more detail below, whereby the definitions made in connection with the metal interference pigments according to the invention apply equally, unless otherwise stated below.

In step (a) of the manufacturing process according to the invention, aluminum platelets with an average thickness in the range of from 5 nm to 600 nm, which are optionally passivated, are provided. For this purpose, the aluminum platelets can be provided in suspended form. An organic solvent can be used to suspend the aluminum platelets, such as isopropanol, which is also particularly suitable with regard to the subsequent coating process in step (b).

In step (b) of the manufacturing process according to the invention, the aluminum platelets provided in step (a) are coated with a layer A of silicon dioxide. This can be done by hydrolytic decomposition of an organic silicon compound. An example of an organic silicon compound is tetraethyl orthosilicate (TEOS), which is also known as tetraethoxysilane. In principle, however, any other organic silicon compound can also be used, provided it has hydrolyzable groups. Alternatively, the coating in step (b) can be carried out by precipitation of water glass.

For coating in step (b), the hydrolytic decomposition is preferably carried out in the presence of a base or an acid as a catalyst. Suitable basic catalysts include alkaline solutions such as sodium hydroxide solution or potassium hydroxide solution and, in particular, aqueous ammonia solutions. Suitable acidic catalysts include phosphoric acid and carboxylic acids such as acetic acid and oxalic acid. For hydrolytic decomposition, water must be present in at least the stoichiometrically required amount, whereby an excess of water is usually used. For temperature control, it is advisable to heat the reaction mixture gradually to 70° C. to 75° C. within 10 hours to 48 hours.

If the coating in step (b) is carried out by precipitation of water glass, a solution of sodium silicate (DAB6) is typically added within 2 hours at 70° C. Depending on the size of the reactor and the pigment surface, dosing takes place at a rate of 0.1 to 0.2 l/min, whereby the pH value is kept constant at 8.0 with diluted sulphuric acid. Stirring is then continued for 15 minutes, during which the pH value hardly changes.

After hydrolytic decomposition of the organic silicon compound or precipitation of the water glass, the aluminum platelets coated with layer A are separated from the other components of the reaction mixture using a filter press and washed. Further details concerning the coating process in step (b) are known to the skilled person and can be found, for example, in WO 2015/014484 A1.

In step (c) of the manufacturing process according to the invention, the layer A obtained in step (b) is coated with a layer B of iron(III) oxide doped with a dopant element selected from the group consisting of tungsten, indium, gallium and titanium. This is done by precipitation of an iron salt in the presence of a dopant salt selected from the group consisting of a tungsten salt, an indium salt, a gallium salt and a titanium salt. The iron salt is typically iron(III) chloride, although other iron salts may also be used provided they can ultimately be precipitated to iron(III) oxide. Without being limited to this, the dopant salt can be selected from the group consisting of sodium tungstate (dihydrate), indium(III) chloride, gallium(III) nitrate and titanium(IV) oxychloride (x hydrogen chloride). Sodium tungstate (dihydrate) in particular has proven to be advantageous for doping due to its easy availability. In principle, however, dopant salts other than those mentioned above are also conceivable, provided they can be used for appropriate doping.

For coating in step (c), the aluminum platelets from step (b) coated with layer A of silicon dioxide, which are present as an aqueous slurry after washing, can be used immediately. No resuspension is therefore required. The pH value is then adjusted to about 3.4 by adding an acid. An aqueous solution of the iron salt is then added. At the same time, an aqueous ammonia solution or similar is added. This induces precipitation and at the same time keeps the pH constant, which would otherwise decrease as a result of the precipitation reaction, as would be the case when using iron(III) chloride due to the release of hydrogen chloride. The dopant salt can be presented either in the aqueous solution of the iron salt, for example in the case of indium(III) chloride, gallium(III) nitrate and titanium(IV) oxychloride (x hydrogen chloride), or in the aqueous ammonia solution or the like, for example in the case of sodium tungstate (dihydrate). The amount of iron salt is selected so that 60 to 85 parts by mass iron(III) oxide are present in the metal interference pigments, based on 10 parts by mass aluminum. The amount of dopant salt is selected so that the molar fraction of the dopant element in layer B, based on the total molar amount of iron and dopant element, is 0.5 mol % to 10 mol %. This ensures that the metal interference pigments have a yellow hue with a green tint, equivalent to a hue angle h_{ab}15° of at least 85, with high color saturation, equivalent to a hue C*_{ab}15° of at least 55.

As a rule, the iron salt used is quantitatively converted during the coating process in step (b). The same applies to the dopant salt.

After precipitation of the iron salt in the presence of the dopant salt, the pH value is adjusted to about 5. After cooling and washing the aluminum platelets coated with layer A and layer B, they are vacuum dried at a temperature of 60° C. The aluminum platelets coated with layer A and layer B are then subjected to thermal treatment, which is characterized by holding at a temperature of 250° C. to 400° C. for a period of 30 minutes to 2 hours. This converts the initially formed iron(III) hydroxide, doped with a dopant element selected from the group consisting of tungsten, indium, gallium and titanium, into the corresponding iron(III) oxide. Further details concerning the precipitation in step (c) are known to the skilled person and can be found, for example, in WO 2015/014484 A1.

The metal interference pigments obtained in step (c) can now be used immediately. If necessary, in a subsequent step (d), layer B can be provided with a surface coating, which is formed from organic polymers, silanes or siloxanes, for example. The procedure in this regard is described in detail in WO 2015/044188 A1, among others. If the surface coating is composed of silicon dioxide, the method can be carried out as in step (b).

Finally, the present invention provides the use of the metal interference pigments according to the invention for coloring paints, printing inks, inks, plastics, glasses, ceramics and preparations for decorative cosmetics. By coloring using the metal interference pigments according to the invention, the respective product is given a yellow hue with a green tint and high color saturation at the same time. This is not possible with the metal interference pigments known from the prior art.

### EXAMPLES

The following examples serve to further explain the present invention, but are not limited thereto.

In each of the following examples and comparative examples, 600 g of an aqueous suspension of passivated aluminum platelets coated with an approximately 40 nm thick layer of silicon dioxide were used. The commercially available aluminum platelets (Decomet® from Schlenk Metallic Pigments GmbH) were vacuum-metallized pigments with an average thickness of about 25 nm and a diameter d₅₀ of about 12 μm. The solids content of the aqueous suspension was 7.5% by mass. Accordingly, the aqueous suspension contained 45 g of the passivated aluminum platelets coated with a layer of silicon dioxide, of which about 15 g was accounted for by the aluminum platelets.

The SiO₂ layer was formed on the passivated aluminum platelets as follows: 153.5 g of a suspension of the vacuum-metallized pigments in isopropanol with a solids content of 14.6 mass % was placed in a container, diluted with 100.5 g of ethanol and heated to a temperature of 70° C. 3.5 g of a 10% solution of potassium hydroxide in ethanol was then added. Subsequently, 3.5 g of a 10% solution of potassium hydroxide in ethanol was added. At a temperature of 70° C., 53.4 g of TEOS and a mixture of 170 g of water and 10.9 g of a 25% solution of ammonia in water were added successively. After a reaction time of 30 minutes, a second addition of TEOS (46.6 g) was made, after a reaction time of a further 30 minutes, a third addition of TEOS (41.3 g) was made and after a reaction time of a further 30 minutes, a fourth addition of TEOS (17.0 g) was made, followed by a final reaction time of one hour. Subsequently, 300 g of water were added and the mixture was transferred to a larger vessel. The mixture was then further diluted by adding 2200 g of water while stirring. Subsequently, 0.5 g of citric acid was added, followed by sedimentation for a period of 12 hours to 24 hours. The supernatant was removed and water was added again. After renewed sedimentation for a period of 12 hours to 24 hours, the supernatant was removed again. Finally, water was added until an aqueous suspension with a solids content of 7.5% by mass was obtained, as indicated above.

### Example A

After heating the aqueous suspension to a temperature of around 75° C. and adjusting the pH to around 3.4, 518.0 g of a 40% solution of iron(III) chloride in water was added. In parallel, 365.8 g of an 18.25% solution of ammonia in water was added to induce precipitation and keep the pH constant. Sodium tungstate (dihydrate) was used as the dopant salt, which had previously been added to the aqueous ammonia solution. The dopant salt accounted for 8.2 g of the aqueous ammonia solution, corresponding to a mass fraction of about 2.25 mass % sodium tungstate (dihydrate) in the aqueous ammonia solution. Coating with layer B was carried out in such a way that 68.0 g of iron(III) oxide, based on 10 g of aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example B

After heating the aqueous suspension to a temperature of about 75° C. and adjusting the pH to about 3.4, 540.8 g of a 40% solution of iron(III) chloride in water was added. In parallel, 382.0 g of an 18.25% solution of ammonia in water was added to induce precipitation and keep the pH constant. Sodium tungstate (dihydrate) was used as the dopant salt, which had previously been added to the aqueous ammonia solution. The dopant salt accounted for 8.6 g of the aqueous ammonia solution, corresponding to a mass fraction of about 2.25 mass % sodium tungstate (dihydrate) in the aqueous ammonia solution. Coating with layer B was carried out in such a way that the metal interference pigments contained 71.0 g iron(III) oxide, based on 10 g aluminum. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example C

After heating the aqueous suspension to a temperature of about 75° C. and adjusting the pH to about 3.4, 492.8 g of a 40% solution of iron(III) chloride in water was added. In parallel, 364.9 g of an 18.25% solution of ammonia in water was added to induce precipitation and keep the pH constant. Sodium tungstate (dihydrate) was used as the dopant salt, which had previously been added to the aqueous ammonia solution. The dopant salt accounted for 24.7 g of the aqueous ammonia solution, corresponding to a mass fraction of about 6.76% by mass of sodium tungstate (dihydrate) in the aqueous ammonia solution. Coating with layer B was carried out in such a way that the metal interference pigments contained 64.7 g iron(III) oxide, based on 10 g aluminum. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example D

After heating the aqueous suspension to a temperature of about 75° C. and adjusting the pH to about 3.4, 519.5 g of a 40% solution of iron(III) chloride in water was added. In parallel, 384.7 g of an 18.25% solution of ammonia in water was added to induce precipitation and keep the pH constant. Sodium tungstate (dihydrate) was used as the dopant salt, which had previously been added to the aqueous ammonia solution. The dopant salt accounted for 26.0 g of the aqueous ammonia solution, corresponding to a mass fraction of about 6.76% by mass of sodium tungstate (dihydrate) in the aqueous ammonia solution. Coating with layer B was carried out in such a way that 68.2 g of iron(III) oxide, based on 10 g of aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example E

After heating the aqueous suspension to a temperature of about 75° C. and adjusting the pH to about 3.4, 537.0 g of a 40% solution of iron(III) chloride in water was added. In parallel, 397.6 g of an 18.25% solution of ammonia in water was added to induce precipitation and keep the pH constant. Sodium tungstate (dihydrate) was used as the dopant salt, which had previously been added to the aqueous ammonia solution. The dopant salt accounted for 26.9 g of the aqueous ammonia solution, corresponding to a mass fraction of about 6.76% by mass of sodium tungstate (dihydrate) in the aqueous ammonia solution. Coating with layer B was carried out in such a way that 70.5 g of iron(III) oxide, based on 10 g of aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example F

After heating the aqueous suspension to a temperature of about 75° C. and adjusting the pH to about 3.4, 542.1 g of a 40% solution of iron(III) chloride in water was added. In parallel, 368.1 g of an 18.25% solution of ammonia in water was added to induce precipitation and keep the pH constant. Indium(III) chloride was used as the dopant salt, which had previously been added to the aqueous iron(III) chloride solution. The dopant salt accounted for 8.9 g of the aqueous iron(III) chloride solution, corresponding to a mass fraction of about 1.65% indium(III) chloride by mass in the aqueous iron(III) chloride solution. Coating with layer B was carried out in such a way that 70.0 g iron(III) oxide, based on 10 g aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example G

After heating the aqueous suspension to a temperature of about 75° C. and adjusting the pH to about 3.4, 493.1 g of a 40% solution of iron(III) chloride in water was added. In parallel, 333.9 g of an 18.25% solution of ammonia in water was added to induce precipitation and keep the pH constant. Gallium(III) nitrate was used as the dopant salt, which had previously been added to the aqueous iron(III) chloride solution. The dopant salt accounted for 9.4 g of the aqueous iron(III) chloride solution, corresponding to a mass fraction of about 1.91% gallium(III) nitrate by mass in the aqueous iron(III) chloride solution. Coating with layer B was carried out in such a way that 63.5 g iron(III) oxide, based on 10 g aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example H

After heating the aqueous suspension to a temperature of about 75° C. and adjusting the pH to about 3.4, 548.3 g of a 40% solution of iron(III) chloride in water was added. In parallel, 371.3 g of an 18.25% solution of ammonia in water was added to induce precipitation and keep the pH constant. Gallium(III) nitrate was used as the dopant salt, which had previously been added to the aqueous iron(III) chloride solution. The dopant salt accounted for 10.5 g of the aqueous iron(III) chloride solution, corresponding to a mass fraction of approximately 1.91% gallium(III) nitrate by mass in the aqueous iron(III) chloride solution. Coating with layer B was carried out in such a way that 70.6 g iron(III) oxide, based on 10 g aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Example I

After heating the aqueous suspension to a temperature of about 75° C. and adjusting the pH to about 3.4, 569.4 g of a 40% solution of iron(III) chloride in water was added. In parallel, 356.6 g of an 18.25% solution of ammonia in water was added to induce precipitation and keep the pH constant. Titanium(IV) oxychloride (x hydrogen chloride) was used as the dopant salt, which had previously been added to the aqueous iron(III) chloride solution. The dopant salt accounted for 53.0 g of the aqueous iron(III) chloride solution, corresponding to a mass fraction of about 9.30 mass % titanium(IV) oxychloride (x hydrogen chloride) in the aqueous iron(III) chloride solution. Coating with layer B was carried out in such a way that 67.8 g iron(III) oxide, based on 10 g aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Comparative Example A

After heating the aqueous suspension to a temperature of about 75° C. and adjusting the pH to about 3.4, 490.6 g of a 40% solution of iron(III) chloride in water was added. At the same time, 338.7 g of an 18.25% solution of ammonia in water was added to induce precipitation and keep the pH constant. Coating with layer B was carried out in such a way that the metal interference pigments contained 64.4 g iron(III) oxide, based on 10 g aluminum. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

### Comparative Example B

After heating the aqueous suspension to a temperature of about 75° C. and adjusting the pH to about 3.4, 518.7 g of a 40% solution of iron(III) chloride in water was added. At the same time, 358.1 g of an 18.25% solution of ammonia in water was added to induce precipitation and keep the pH constant. Coating with layer B was carried out in such a way that 68.1 g of iron(III) oxide, based on 10 g of aluminum, was present in the metal interference pigments. For this purpose, appropriate preliminary tests were first carried out taking into account the aluminum platelets used.

The pH value was then adjusted to around 5. After cooling and washing, vacuum drying was carried out at a temperature of around 60° C. Finally, the solid obtained in this way was subjected to thermal treatment, whereby it was first heated from room temperature to 270° C. at a heating rate of 1.5° C./min and then heated from 270° C. to 370° C. at a heating rate of 0.5° C./min, followed by holding at 370° C. for one hour.

After thermal treatment, the resulting metal interference pigments were examined for their coloristic properties, namely hue angle h_{ab}15° and hue C*_{ab}15°, as described above. The results are shown in Table 1.

TABLE 1

| | Dopant salt | m Fe₂O₃/ | Hue angle | Hue |
|---|---|---|---|---|
| | mass fraction | 10 g Al | h_{ab}15° | C*_{ab}15° |
| Example | | | | |
| A | Na₂WO₄•2H₂O• | 68.0 | 86.7 | 69.3 |
| | 2.25 mass % | | | |
| B | Na₂WO₄•2H₂O | 71.0 | 85.6 | 77.4 |
| | 2.25 mass % | | | |
| C | Na₂WO₄•2H₂O | 64.7 | 88.7 | 61.3 |
| | 6.76 mass % | | | |
| D | Na₂WO₄•2H₂O | 68.2 | 87.9 | 70.5 |
| | 6.76 mass % | | | |
| E | Na₂WO₄•2H₂O | 70.5 | 86.5 | 80.4 |
| | 6.76 mass % | | | |
| F | InCl₃ | 70.0 | 85.7 | 81.2 |
| | 1.65 mass % | | | |
| G | Ga(NO₃)₃ | 63.5 | 86.2 | 57.3 |
| | 1.91 mass % | | | |
| H | Ga(NO₃)₃ | 70.6 | 85.2 | 76.3 |
| | 1.91 mass % | | | |
| I | TiOCl₂•xHCl | 67.8 | 85.1 | 84.0 |
| | 9.30 mass % | | | |
| Comparative | | | | |
| example | | | | |
| A | — | 64.4 | 79.8 | 70.0 |
| B | — | 68.1 | 79.7 | 79.4 |

As can be seen from the above examples A to I, a hue angle h_{ab}15° of at least 85 with a hue C*_{ab}15° of at least 55 can be achieved by doping with a dopant element selected from the group consisting of tungsten, indium, gallium and titanium. The metal interference pigments from examples A to I were therefore characterized by a yellow hue with a green tint and high color saturation. In contrast, without doping, only a hue angle h_{ab}15° of just under 80 could be achieved, as can be seen from the above comparative examples A and B. The metal interference pigments from comparative examples A and B therefore did not exhibit a yellow hue with a green tint.

1. Metal interference pigments comprising aluminum platelets having an average thickness in the range of from 5 nm to 600 nm, which are optionally passivated and which are coated with a layer A and a layer B in this order,
wherein layer A is composed of silicon dioxide and layer B is composed of iron(III) oxide doped with a dopant element selected from the group consisting of tungsten, indium, gallium and titanium,
wherein the molar fraction of the dopant element in layer B, based on the total molar amount of iron and the dopant element, is from 0.5 mol % to 10 mol %, and
wherein 60 to 85 parts by mass of iron(III) oxide, based on 10 parts by mass of aluminum, are present in the metal interference pigments.

2. The metal interference pigments according to claim 1, wherein the diameter d₅₀ of the aluminum platelets is 5 μm to 100 μm.

3. The metal interference pigments according to claim 1, wherein the aluminum platelets have a thickness variation in the range of 10% to 40%.

4. The metal interference pigments according to claim 1, wherein the aluminum platelets are vacuum-metallized pigments.

5. The metal interference pigments according to claim 1, wherein layer A has an average thickness in the range of from 5 nm to 200 nm.

6. The metal interference pigments according to claim 1, wherein the dopant element is tungsten.

7. The metal interference pigments according to claim 1, wherein the layer B has an average thickness in the range of from 15 nm to 300 nm.

8. The metal interference pigments according to claim 1, wherein the layer B is provided with a surface coating.

9. The metal interference pigments according to claim 1, wherein the metal interference pigments have a hue angle h_{ab}15° of at least 85 at a hue C*_{ab}15° of at least 55.

10. The metal interference pigments according to claim 1, wherein the metal interference pigments have a color distance ΔE110° of less than 1.5.

11. A method for producing the metal interference pigments according to claim 1, comprising the following steps (a) to (c):
(a) providing aluminum platelets having an average thickness in the range of from 5 nm to 600 nm, which are optionally passivated;
(b) coating the aluminum platelets provided in step (a) with a layer A of silicon dioxide by hydrolytic decomposition of an organic silicon compound or by precipitation of water glass; and
(c) coating the layer A obtained in step (b) with a layer B of iron(III) oxide doped with a dopant element selected from the group consisting of tungsten, indium, gallium and titanium by precipitation of an iron salt in the presence of a dopant salt selected from the group consisting of a tungsten salt, an indium salt, a gallium salt and a titanium salt.

12. The method according to claim 11, wherein the dopant salt is selected from the group consisting of sodium tungstate (dihydrate), indium(III) chloride, gallium(III) nitrate, and titanium(IV) oxychloride (x hydrogen chloride).

13. The method according to claim 12, wherein the dopant salt is sodium tungstate (dihydrate).

14. The method according to claim 11, further comprising the following step (d):
(d) providing the layer B obtained in step (c) with a surface coating.

15. A material comprising the metal interference pigments according to claim 1.

16. The material of claim 15, wherein the material is selected from a paint, a printing ink, a plastic, a glass, a ceramic, or a decorative cosmetic material.
